(19) United States
(12) Patent Application Publication
(10) Pub. No.: US 2009/0280237 A1
(43) Pub. Date: Nov. 12, 2009

(54) Coating Mass

(76) Inventors: Sascha Tödter-König, Hamburg (DE); Gerold Schmidt, Hamburg (DE); Klaus-Wilhelm Lienert, Hamburg (DE)

Correspondence Address: FRIEDRICH KUEFFNER, 317 MADISON AVENUE, SUITE 910, NEW YORK, NY, 10017, US

(21) Appl. No.: 11/990,527

(22) PCT Filed: Aug. 23, 2006
(86) PCT No.: PCT/EP2006/065572

§ 371 Date: Mar. 11, 2008

(30) Foreign Application Priority Data
Aug. 25, 2005 (DE) 10 2005 040 126.0

(51) Int. Cl. C08L 67/00; B05D 5/12

(52) U.S. Cl. 427/96.6; 524/601; 524/599

(57) ABSTRACT

The present invention relates to coating compositions for flat assemblies, hybrids, SMD assemblies, comprising at least one binder or binder mixtures which are curable at 60° C.-120° C., preferably at 70° C.-110° C., more particularly at 80° C.-90° C., and also to a process for preparing them and to their use for flat assemblies in electronics, hybrids, SMD assemblies and assembled printed circuit boards.

This application claims the priority of DE 10 2005 040 126.0-43.

The present invention relates to a coating composition, to its preparation and to its use more particularly in the field of flat assemblies, hybrids and SMD assemblies and assembled printed circuit boards.

A coating composition for flat assemblies, hybrids, SMD assemblies and other components which are used on printed circuit boards is required to protect the coated components from moisture, chemicals, dust, etc. A further intention is that the protective coat should increase the security of electronic assemblies with respect to climate and tracking current. The thermal load-bearing capacity must be appropriate to the field of use. Effective adhesion to a variety of substrates is taken to be self-evident. Processing is typically by the select coat or selective dipping process. If the temperature of the composition is raised in order to reduce the viscosity, both spraying and injecting processes can be employed. With a coating composition of this kind, excellent dry films with thicknesses of up to several millimetres are obtained.

State of the art is the use of air-drying or oven-drying varnishes. The binder is typically an alkyd resin, an acrylic resin or a polyurethane resin. As a form of surface protection, these varnishes have long been known and described as well (W. Tillar Shugg, Handbook of Electrical and Electronic Insulating Materials, IEEE Press 1995). The varnishes typically include up to fifty or more percent solvent. When the varnishes are cured, the solvents are emitted to the ambient air; this is nowadays undesirable. Solvent systems for this utility are formulations based on polyurethane resins and epoxy resins.

The curing mechanisms of the one-component epoxy resins which polymerize by means of Lewis acids are described exhaustively in the literature (S. A. Zahir, E. Hubler, D. Baumann, Th. Haug, K. Meier, Polymers, p. 273, B. G. Teubner Stuttgart 1997).

U.S. Pat. No. 6,297,344 and U.S. Pat. No. 6,207,732 describe one-component epoxy resins which are used as adhesives. The curing temperature is 120° C.

WO 94/10223 describes formulations which include epoxy resin and which are first activated with UV light and then cured thermally at 150° C. in one hour. Applications are casting, masking and adhesive bonding of electrical and electronic components.

US 20030200701 describes formulations which are cured at 140° C.

The problem addressed by the present invention is that of providing a low-viscosity coating composition for coating thermolabile substrates, examples being flat assemblies, such as printed circuit boards, hybrids, such as hybrid microsystems, SMD assemblies, etc., which require low thermal curing energy and which require less curing time than the existing state of the art, and which can be processed on the typical lines, and which can be used as a protective coating.

This problem is solved by a coating composition comprising a binder or binder mixtures which can be cured above 60° C. and below 120° C. Particularly preferred binders or binder mixtures are those which are curable at 70° C.-110° C., more particularly at 80° C.-90° C.

The coating composition of the invention preferably comprises two or more catalysts which enable the coating composition to be cured above 60° C. and below 120° C., preferably at 70° C.-110° C., more particularly at 80° C.-90° C. Employed in accordance with the invention are catalysts which enable curing at the stated temperatures within 50 minutes, preferably 30 minutes. Particularly preferred catalysts are those which enable curing within 20-50 minutes, with very particular preference within 25-40 minutes. The invention also provides, accordingly, for the use of these catalysts for coating materials for thermolabile substrates.

Besides the stated binders and catalysts, the coating composition may comprise further typical auxiliary and adjuvant components.

Particularly preferred in accordance with the invention is a coating composition comprising the components A, B, C and, where appropriate, D, where

component A
a) comprises at least one binder,

component B
b) comprises one or more reactive diluents

component C
c) comprises a catalyst which enables the coating composition of the invention to be cured at 60° C.-120° C., preferably 70° C.-110° C., more particularly at 80-90° C.

and component D
d) comprises one or more substances selected from the group consisting of corrosion inhibitors, defoamers, flow control agents and wetting agents.

In one inventively preferred embodiment the coating material may be composed of components A to D. It is also possible for component B to be composed of a reactive diluent, component C of a curing catalyst, and component D of the stated corrosion inhibitors, defoamers, flow control agents and wetting agents.

In accordance with the invention component A preferably comprises a binder from the class of the cycloaliphatic diepoxy resins. With particular preference the component is composed of such resins. Examples of these resins are bis(3,4-epoxycyclohexylmethyl) adipate or 3,4-epoxycyclohexylmethyl 3,4-epoxycyclohexanecarboxylate. The resins may be used alone or in a mixture. Apart from the stated resins, binders which have similar properties are also suitable. In other words, alone or in a mixture, or in the presence of a catalyst, the binders must be capable of curing above 60° C. and below 120° C., preferably at 70° C.-110° C., more particularly at 80° C.-90° C.

Suitable components B are preferably compounds which copolymerize cationically with the epoxy resins of the invention. Such compounds may be, for example, monoepoxides, such as limonene oxide, for example, and also epoxy novolaks. It is also possible to use polyols of the polyethylene glycol or polypropylene glycol type having linear or branched structures, homopolymers or copolymers. Furthermore, it is possible to use naturally occurring OH-functionalized oils, such as castor oil. Vinyl ethers, such as triethylene glycol divinyl ether or cyclohexanedimethanol divinyl ether, can likewise be employed. Suitability is possessed, further, by alkylene carbonates, such as propylene carbonate. Also suitable in accordance with the invention as reactive diluents for epoxy resins are oxetanes, such as 3-ethylhydroxymethyloxetane, terephthalatebisoxetane or bisphenylenebisoxetane.

Component C comprises at least one catalyst suitable for curing the coating materials at temperatures above 60° C. and below 120° C., preferably at 70° C.-110° C., more particularly at 80° C.-90° C. The curing catalysts shall enable curing preferably within 50 minutes. Particular preference is given to curing within 20-50 minutes, very preferably within 25-40 minutes, most preferably within 30 minutes. In accordance with the invention it is preferred to use quaternary ammonium hexafluoroantimonates. Preference is given in this context to using (4-methoxybenzyl)dimethylphenylammonium hexafluoroantimonate as a curing catalyst. It allows the coating composition of the invention to cure at the temperatures stated above and within the stated time periods.

Component D comprises one or more substances selected from the group consisting of corrosion inhibitors, defoamers, flow control agents and wetting agents.

The coating composition of the invention can be prepared by mixing components A to D with one another and then storing them or passing them on to be used. Tests have shown that the coating compositions of the invention are stable on storage for weeks.

In accordance with the invention, binder of component A, containing epoxy resin, is preferably mixed homogeneously with the other components. This produces a coating composition which, depending on its constitution, can have different viscosities. Coating compositions used for coating flat assemblies in electronics, hybrids and SMD assemblies typically have viscosities of between 300 mPa·s and 600 mPa·s, measured at 25° C., depending on application, on processing technology and on desired coat thickness. The coating composition of the invention is suitable more particularly for the coating of flat assemblies in electronics, such as printed circuit boards, hybrids, such as hybrid microsystems and SMD assemblies, and also assembled printed circuit boards. The coating has outstanding adhesion and is VOC-free or low in VOC. Furthermore, the coating composition of the invention can also be used to impregnate electrical windings or as a protective varnish for electrical windings.

The invention is described in more detail below with reference to the examples. Testing takes place in accordance with DIN and IEC standards. The properties of the varnish films of the formulations from Example 1 and from Comparative Example 5 show comparable values. This means that curing with the catalyst of the invention at 90° C. is equivalent to curing in accordance with the existing state of the art at 150° C.

### EXAMPLES

### Example 1

Added with stirring to 2031.0 g of 3,4-epoxycyclohexylmethyl 3,4-epoxycyclohexanecarboxylate are 55.0 g of Lupranol^{Ò} 3300 (polyetherpolyol from BASF) and a solution of 7 g of (4-methoxybenzyl)dimethylphenylammonium hexafluoroantimonate in 7 g of propylene carbonate. The coating composition was stable on storage for weeks and had a viscosity of 500 mPas/cone/D at 25° C.

The coating composition cures impeccably in coat thicknesses of 4 mm in 30 minutes at 90° C. The curing losses are less than 0.1%. In a coat thickness of 0.1 mm, the varnish film adheres impeccably to a degreased metal sheet. A mandrel bending test (3 mm) is passed impeccably. The contact resistance at 23° C. is 1.7 E+15 ohm*cm. After 7 days of water storage the contact resistance at 23° C. is 1.8 E+14 ohm*cm. The dielectric strength is 230 kV/mm (at 23° C.) and 228 kV/mm (at 155° C.).

The varnish is used to impregnate drilled rods in accordance with IEC 61033 (method A), and, after curing (30 minutes at 90° C.), the baking resistance is measured. It is 290 N at 23° C.

### Example 2

1722.0 g of 3,4-epoxycyclohexylmethyl 3,4-epoxycyclohexanecarboxylate, 390.0 g of bis(3,4-epoxycyclohexylmethyl) adipate, 210.0 g of Lupranol^{Ò} 2042, 63.0 g of LupranolÒ 3300 (polyetherpolyols from BASF) and a solution of (4-methoxybenzyl)dimethylphenylammonium hexafluoroantimonate in 7.9 g of propylene carbonate are mixed homogeneously with stirring. The coating composition was stable on storage for weeks and had a viscosity of 580 mPas at 25° C.

The composition cured in coat thicknesses of 4 mm in 30 min/90° C. in a forced-air oven to form a flexible film. The curing losses are less than 0.2%. In a coat thickness of 0.1 mm, the varnish film adheres impeccably to a degreased metal sheet. A mandrel bending test (3 mm) is passed impeccably. The contact resistance at 23° C. is 4.5 E+14 ohm*cm. After 7 days of water storage the contact resistance at 23° C. is 8.5 E+13 ohm*cm. The dielectric strength is 221 kV/mm (at 23° C.) and 210 kV/mm (at 155° C.).

The varnish is used to impregnate drilled rods in accordance with IEC 61033 (method A), and, after curing (30 minutes at 90° C.), the baking resistance is measured. It is 190 N at 23° C.

### Example 3

A coating composition is prepared with stirring from 2100 g of bis(3,4-epoxycyclohexylmethyl) adipate, 400.0 g of Lupranol^{Ò} 3530 (polyetherpolyol from BASF) and a solution of 12.5 g (4-methoxybenzyl)dimethylphenylammonium hexafluoroantimonate in 12.5 g of propylene carbonate. The formulation is stable on storage and has a viscosity of 600 mPa·s/cone at 25° C. In a coat thickness of 4 mm it cures in 30 minutes at 90° C. in a forced-air oven to give a very flexible film.

### Example 4

A coating composition is prepared with stirring from 1900 g of bis(3,4-epoxycyclohexylmethyl) adipate, 600.0 g of castor oil and a solution of 12.5 g (4-methoxybenzyl)dimethylphenylammonium hexafluoroantimonate in 12.5 g of propylene carbonate. It has a viscosity of 600 mPa·s/cone at 25° C. In a coat thickness of 4 mm the composition cured in 30 minutes at 90° C. in a forced-air oven to give a very flexible film.

### Comparative Example 5

The experiment from Example 1 is repeated but using as the catalyst a commercially customary boron trifluorideoctylamine complex.

At 90° C. the composition did not cure, even on prolonged storage in the oven. The composition cured in 50 minutes at 150° C. in a forced-air oven. The curing losses are of the order of 1.8%. In a coat thickness of 0.1 mm, the varnish film adheres impeccably to a degreased metal sheet. A mandrel bending test (3 mm) is passed impeccably. The contact resistance at 23° C. is 5.3 E+14 ohm*cm and after 7 days of water storage at 23° C. it is 1.1 E+13 ohm*cm. The dielectric strength is in each case 225 kV/mm (at 23° C.) and 212 kV/mm (at 155° C.).

1. Coating composition for thermolabile substrates, more particularly flat assemblies, hybrids and SMD assemblies, comprising at least one binder or binder mixtures which are curable below 120° C. and above 60° C.

2. Coating composition according to claim 1, wherein the binders or binder mixtures are curable at 70° C.-110° C., more particularly at 80° C.-90° C.

3. Coating composition according to claim 1, wherein it comprises a curing catalyst.

4. Coating composition according to claim 1, comprising at least one reactive diluent and, if desired, corrosion inhibitors, defoamers, flow control agents and wetting agents.

5. Coating composition according to claim 1, wherein it comprises epoxy resins as binders.

6. Coating composition according to claim 1, wherein it comprises epoxy resins as cycloaliphatic binders.

7. Coating composition according to claim 1, wherein it comprises bis (3,4-epoxycyclohexylmethyl) adipate or 3,4-epoxycyclohexylmethyl 3,4-epoxycyclohexanecarboxylate or mixtures thereof as binder(s).

8. Coating composition according to claim 1, wherein it comprises a catalyst which enables curing within 20 to 50, preferably 30 minutes.

9. Coating composition according to claim 1, wherein it comprises quaternary ammonium hexafluoroantimonates as catalyst.

10. Coating composition according to claim 1, wherein it comprises (4-methoxybenzyl) dimethylphenylammonium hexafluoroantimonate as catalyst.

11. Coating composition according to claim 1, wherein it comprises compounds which polymerize cationically with epoxy resins as reactive diluents.

12. Coating composition according to claim 1, wherein it comprises monoepoxides, polyols of the polyethylene glycol or polypropylene glycol type as reactive diluents.

13. Coating composition according to claim 1, wherein it comprises naturally occurring OH-functionalized oils, preferably castor oil, as reactive diluents.

14. Coating composition according to claim 1, wherein it comprises vinyl ethers, preferably triethylene glycol divinyl ether or cyclohexanedimethanol divinyl ether, as reactive diluents.

15. Coating composition according to claim 1, wherein it comprises alkylene carbonates, preferably propylene carbonate, as reactive diluents.

16. Coating composition according to claim 1, wherein it comprises oxetanes as reactive diluents, preferably 3-ethylhydroxymethyloxetane, terephthalatebisoxetane or bisphenylenebisoxetane.

17. Use of the coating composition according to claim 1 for flat assemblies, hybrids, SMD assemblies, for impregnating electrical windings or as protective varnish for electrical windings.

18. Method of coating thermolabile substrates by applying a coating composition according to claim 1 to the substrate and curing it at temperatures of above 60° C. and below 120° C.
